(19) United States
(12) Patent Application Publication
(10) Pub. No.: US 2010/0057473 A1
(43) Pub. Date: Mar. 4, 2010

(54) METHOD AND SYSTEM FOR DUAL VOICE PATH PROCESSING IN AN AUDIO CODEC

(76) Inventors: Hongwei Kong, Denville, NJ (US); Thirunathan Sutharsan, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/248,533

(22) Filed: Oct. 9, 2008

Related U.S. Application Data
(60) Provisional application No. 61/091,883, filed on Aug. 26, 2008.

(51) Int. Cl. G10L 19/00

(52) U.S. Cl. 704/500; 704/E19.023

(57) ABSTRACT

Aspects of a method and system for dual voice path processing in an audio CODEC may enable selecting two or more signals received via one or more audio input devices, and filtering and down-sampling each of the selected signals via two or more signal processing branches. Furthermore, an output sample rate of each of the signal processing branches may be configured independently. The signal processing branches may each comprise one or more IIR filters with configurable coefficients and one or more cascaded-integrate-comb (CIC) decimation filters having a configurable decimation ratio. A first of the selected signals, may be filtered and/or down-sampled to generate a signal having a first, lower, sample rate, and a second of the signals may be filtered and/or down-sampled to generate a signal having a second, higher, sample rate. One or more post-processing algorithms such as audio beamforming may also be performed on the selected signals.

### CROSS-REFERENCE TO RELATED APPLICATIONS/INCORPORATION BY REFERENCE

This application makes reference to, claims priority to and claims benefit from U.S. Provisional Patent Application Ser. No. 61/091,883 filed on Aug. 26, 2008.

This application also makes reference to U.S. Provisional Patent Application Ser. No. 61/074,012 filed on Jun. 19, 2008.

Each of the above stated applications is hereby incorporated herein by reference in its entirety.

### FIELD OF THE INVENTION

Certain embodiments of the invention relate to processing of audio signals. More specifically, certain embodiments of the invention relate to a method and system for dual voice path processing in an audio CODEC.

### BACKGROUND OF THE INVENTION

In audio applications, systems that provide audio interface and processing capabilities may be required to support duplex operations, which may comprise the ability to collect audio information through a sensor, microphone, or other type of input device while at the same time being able to drive a speaker, earpiece of other type of output device with processed audio signal. In order to carry out these operations, these systems may utilize audio coding and decoding (codec) devices that provide appropriate gain, filtering, and/or analog-to-digital conversion in the uplink direction to circuitry and/or software that provides audio processing and may also provide appropriate gain, filtering, and/or digital-to-analog conversion in the downlink direction to the output devices.

As audio applications expand, such as new voice and/or audio compression techniques and formats, for example, and as they become embedded into wireless systems, such as mobile phones, for example, novel codec devices may be needed that may provide appropriate processing capabilities to handle the wide range of audio signals and audio signal sources. In this regard, added functionalities and/or capabilities may also be needed to provide users with the flexibilities that new communication and multimedia technologies provide. Moreover, these added functionalities and/or capabilities may need to be implemented in an efficient and flexible manner given the complexity in operational requirements, communication technologies, and the wide range of audio signal sources that may be supported by mobile phones.

The audio inputs to mobile phones may come from a variety of sources, at a number of different sampling rates, and audio quality. Polyphonic ringers, voice, and high quality audio, such as music, are sources that are typically processed in a mobile phone system. The different quality of the audio source places different requirements on the processing circuitry, thus dictating flexibility in the audio processing systems.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for dual voice path processing in an audio CODEC, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, which may be utilized in accordance with an embodiment of the invention.

FIG. 2 is a block diagram illustrating an exemplary audio CODEC interconnection, in accordance with an embodiment of the invention.

FIG. 3 is a block diagram of an exemplary audio transmit processing system in accordance with an embodiment of the invention.

FIG. 4 is a block diagram illustrating exemplary digital audio processing hardware, in accordance with an embodiment of the invention.

FIG. 5 is a flow chart illustrating exemplary steps for simultaneously processing a plurality of voice band signals in an audio CODEC, in accordance with an embodiment of the invention.

### DETAILED DESCRIPTION OF THE INVENTION

Certain aspects of the invention may be found in a method and system for dual voice path processing in an audio CODEC. In this regard, two or more signals received via one or more audio input devices may be selected for processing. The selected signals may be filtered and down-sampled via two or more signal processing branches. Furthermore, an output sample rate of each of the two or more signal processing branches may be configured independently. The two or more signal processing branches may each comprise one or more IIR filters with configurable coefficients. The two or more signal processing branches may each comprise one or more cascaded-integrate-comb (CIC) decimation filters having a configurable decimation ratio. A first of the selected two or more signals, may be filtered and/or down-sampled to generate a signal having a first, lower, sample rate, and a second of the selected two or more signals may be filtered and/or down-sampled to generate a signal having a second, higher, sample rate. In this regard, the signal having first, lower, sample rate may be transmitted to a remote device while the signal having a second, higher, sample rate may be stored in memory. A first of the selected signals and a second of the selected signals may comprise the same or similar audio content. The output sampling rate of the signal processing branches may be 8 kHz or 16 kHz. The filtered and/or down-sampled signals may be combined in such a way that background noise or interferences may be suppressed while the quality of the intended signal may be preserved. The selected audio signals may comprise voice band audio content.

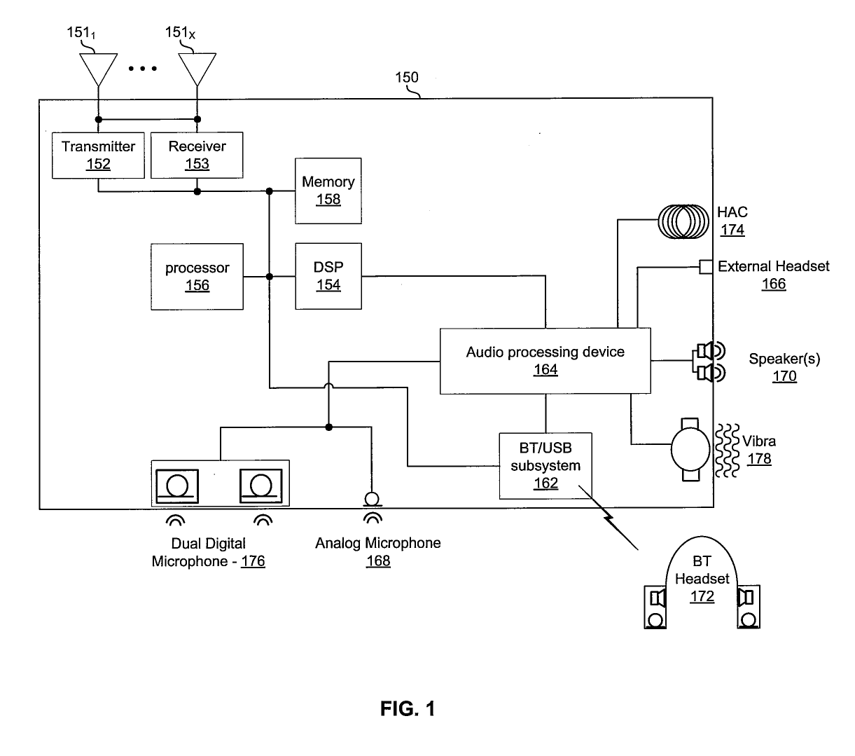

FIG. 1 is a block diagram of an exemplary wireless system, which may be utilized in accordance with an embodiment of the invention. Referring to FIG. 1, the wireless system 150 may comprise one or more antennas 151, a transmitter 152, a receiver 153, a digital signal processor 154, a processor 156, a memory 158, a Bluetooth (BT) subsystem 162, an audio processing device 164, an external headset port 166, an analog microphone 168, speaker(s) 170, a Bluetooth headset 172, a hearing aid compatibility (HAC) coil 174, a dual digital microphone 176, and a vibration transducer 178. The one or more antennas 151 may be used for reception and/or transmission of RF signals. In various embodiments of the invention, different antennas may be utilized for transmission and reception.

The transmitter 152 may comprise suitable logic, circuitry, and/or code that may be operable to modulate and up-convert baseband signals to RF signals for transmission by one or more antennas, which may be represented generically by the antenna 151. The transmitter 152 may be operable to execute other functions, for example, filtering the baseband and/or RF signals, and/or amplifying the baseband and/or RF signals. Although a single transmitter 152 is shown, the invention is not so limited. Accordingly, there may be a plurality of transmitters and/or receivers. In this regard, the plurality of transmitters may enable the wireless system 150 to handle a plurality of wireless protocols and/or standards including cellular, wireless local area networking (WLAN), and personal area networking (PAN). In addition, the transmitter 152 may be combined with the receiver 153 and implemented as a combined transmitter and receiver (transceiver).

The receiver 153 may comprise suitable logic, circuitry, and/or code that may be operable to down-convert and demodulate received RF signals to baseband signals. The RF signals may be received by one or more antennas, which may be represented generically by the antenna 151. The receiver 153 may be operable to execute other functions, for example, filtering the baseband and/or RF signals, and/or amplifying the baseband and/or RF signals. Although a single receiver 153 is shown, the invention is not so limited. Accordingly, there may be a plurality of receivers. In this regard, the plurality of receivers may enable the wireless system 150 to handle a plurality of wireless protocols and/or standards including cellular, WLAN, and PAN. In addition, the receiver 153 may be implemented as a separate transmitter and a separate receiver.

The DSP 154 may comprise suitable logic, circuitry, and/or code that may be operable to process audio signals. In various embodiments of the invention, the DSP 154 may encode, decode, modulate, demodulate, encrypt, and/or decrypt audio signals. In this regard, the DSP 154 may be operable to perform computationally intensive processing of audio signals.

The processor 156 may comprise suitable logic, circuitry, and/or code that may be operable to configure and/or control one or more portions of the system 150, control data transfers between portions of the system 150, and/or otherwise process data. Control and/or data information may be transferred between the processor 156 and one or more of the transmitter 152, the receiver 153, the DSP 154, the memory 158, the audio processing device 164, and the BT and/or USB subsystem 162. The processor 156 may be utilized to update and/or modify programmable parameters and/or values in one or more of the transmitter 152, the receiver 153, the DSP 154, the memory 158, the audio processing device 164, and the BT and/or USB subsystem 162. In this regard, a portion of the programmable parameters may be stored in the system memory 158. The processor 156 may be any suitable processor or controller. For example, the processor 156 may be a reduced instruction set computing (RISC) microprocessor such as an advanced RISC machine (ARM), advanced virtual RISC (AVR), microprocessor without interlocked pipeline stages (MIPS), or programmable intelligent controller (PIC).

The system memory 158 may comprise suitable logic, circuitry, and/or code that may be operable to store a plurality of control and/or data information, including parameters needed to configure one or more of the transmitter 152, the receiver 153, the DSP 154, and/or the audio processing device 164. The system memory 158 may store at least a portion of the programmable parameters that may be manipulated by the processor 156.

In an exemplary embodiment of the invention, the DSP 154 and processor 156 may exchange audio data and control information via the memory 158. For example, the processor 156 may write encoded audio data, such as MP3 or AAC audio, to the memory 158 and the memory may pass the encoded audio data to the DSP 154. Accordingly, the DSP 154 may decode the data and write pulse-code modulated (PCM) audio back into the shared memory for the processor 156 to access and/or to be delivered to the audio processing device 164.

The BT and/or USB subsystem 162 may comprise suitable circuitry, logic, and/or code that may be operable to transmit and receive Bluetooth and/or Universal Serial Bus (USB) signals. The BT and/or USB subsystem 162 may be operable to up-convert, down-convert, modulate, demodulate, and/or otherwise process BT and/or USB signals. In this regard, the BT and/or USB subsystem 162 may handle reception and/or transmission of BT and/or USB signals via a wireless communication medium and/or handle reception and/or transmission of USB signals via a wireline communication medium. Information and/or data received via a BT and/or USB connection may be communicated between the BT and/or USB subsystem 162 and one or more of the transmitter 152, the receiver 153, the DSP 154, the processor 156, the memory 158, and the audio processing device 164. For example, the BT and/or USB subsystem 162 may extract audio from a received BT and/or USB signal and may convey the audio to other portions of the wireless system 150 via an inter-IC sound (I²S) bus. Information and/or data may be communicated from one or more of the transmitter 152, the receiver 153, the DSP 154, the processor 156, the memory 158, and the audio processing device 164 to the BT and/or USB subsystem 162 for transmission over a BT and/or USB connection. For example, audio signals may be received from other portions of the wireless system 150 via an I2S bus and the audio signal may be transmitted via a BT and/or USB connection. Additionally, control and/or feedback information may be communicated between the BT and/or USB subsystem 162 and one or more of the transmitter 152, the receiver 153, the DSP 154, the processor 156, the memory 158, and the audio processing device 164.

The audio processing device 164 may comprise suitable circuitry, logic, and/or code that may be operable to process audio signals received from and/or communicated to input and/or output devices. The input devices may be within or communicatively coupled to the wireless device 150, and may comprise, for example, the analog microphone 168, the stereo speakers 170, the Bluetooth headset 172, the hearing aid compatible (HAC) coil 174, the dual digital microphone 176, and the vibration transducer 178. The audio processing device 164 may up-sample and/or down-sample audio signals to one or more desired sample rates for communication to an audio output device, the DSP 154, and/or the BT and/or USB subsystem 162. In this regard, the audio processing device 164 may also be enabled to handle a plurality of data sampling rate inputs. For example, the audio processing device 164 may accept digital audio signals at sampling rates such as 8 kHz, 11.025 kHz, 12 kHz, 16 kHz, 22.05 kHz, 24 kHz, 32 kHz, 44.1 kHz, and/or 48 kHz. The audio processing device 164 may be enabled to handle a plurality of digital audio inputs of various resolutions, such as 16 or 18-bit resolution, for example. The audio processing device 164 may support mixing of a plurality of audio sources. For example, the audio processing device 164 may support audio sources such as general audio, polyphonic ringer, I²S FM audio, vibration driving signals, and voice. In an exemplary embodiment of the invention, the general audio and polyphonic ringer sources may support the plurality of sampling rates that the audio processing device 164 may be enabled to accept, while the voice source may support a portion of the plurality of sampling rates, such as 8 kHz and 16 kHz.

The audio processing device 164 may utilize a programmable infinite impulse response (IIR) filter and/or a programmable finite impulse response (FIR) filter for at least a portion of the audio sources to compensate for passband amplitude and phase fluctuation for different input and/or output devices. In this regard, filter coefficients may be configured or programmed dynamically based on operations. Moreover, filter coefficients may all be switched in one-shot or may be switched sequentially, for example. The audio processing device 164 may also utilize a modulator, such as a Delta-Sigma (ΔΣ) modulator, for example, to code digital output signals for analog processing. The audio processing device 164 may be referred to, for example, as an audio coding and/or decoding device or CODEC. In various embodiments of the invention, the audio processing device 164 may be implemented in dedicated hardware.

The external headset port 166 may comprise a physical connection for an external headset to be communicatively coupled to the wireless system 150. The headset may, for example, be an analog headset comprising a microphone and a pair of stereo transducers. Alternatively, the headset may be a digital headset which may utilize a protocol such as USB for communicating audio information.

The analog microphone 168 may comprise suitable circuitry, logic, and/or code that may detect sound waves and convert them to electrical signals via a piezoelectric effect, for example. The electrical signals generated by the analog microphone 168 may comprise analog signals that may require analog to digital conversion before processing.

The speaker(s) 170 may comprise one or more speakers that may be operable to generate acoustic waves from electrical signals received from the audio processing device 164. In an exemplary embodiment of the invention, there may be a pair of speakers which may be operable to output acoustic waves corresponding to, for example, left and right stereo channels.

The Bluetooth headset 172 may comprise a wireless headset that may be communicatively coupled to the wireless system 150 via the BT and/or USB subsystem 162. In this manner, the wireless system 150 may be operated in a hands-free mode, for example.

The HAC coil 174 may comprise suitable circuitry, logic, and/or code that may enable communication between the wireless device 150 and a hearing aid, for example. In this regard, audio signals may be magnetically coupled from the HAC coil 174 to a coil in a user's hearing aid.

The dual digital microphone 176 may comprise suitable circuitry, logic, and/or code that may detect sound waves and convert them to electrical signals. The electrical signals generated by the dual digital microphone 176 may comprise digital signals, and thus may not require analog to digital conversion prior to digital processing in the audio processing device 164.

The vibration transducer 178 may comprise suitable circuitry, logic, and/or code that may be operable to notify a user of an incoming call, alerts and/or message to the wireless device 150 without the use of sound. The vibration transducer may generate vibrations that may be in synch with, for example, audio signals such as speech or music.

In operation, audio signals from the receiver 153, the processor 156, and/or the memory 158 may be conveyed to the DSP 154. The DSP 154 may process the signals to generate output baseband audio signals to the audio processing device 164. Additionally, baseband audio signals may be conveyed from the BT and/or USB subsystem 162, the analog microphone 168, and/or the digital microphone 176, to the audio processing device 164.

The audio processing device 164 may process and/or condition one or more of the baseband audio signals to make them suitable for conveyance to one or more of the speaker(s) 170, the headset 166, the HAC 174, the vibration transducer 178, the transmitter 152, and/or the BT and/or USB subsystem 162. In this regard, the audio CODEC 164 may comprise dual voice processing paths, where each path may be configured independently of the other path. In an exemplary embodiment of the invention, dual voice processing paths may enable, for example, having a narrow band (e.g. 8 kHz) voice call while recording the call wideband (e.g. 16 kHz). In this regard, the call may be recorded by storing it to a memory such as the memory 158. In an exemplary embodiment of the invention, dual voice processing paths may enable, for example, beamforming or transmit diversity. In this regard, different processing paths may each be communicatively coupled to different one of the antennas 151.

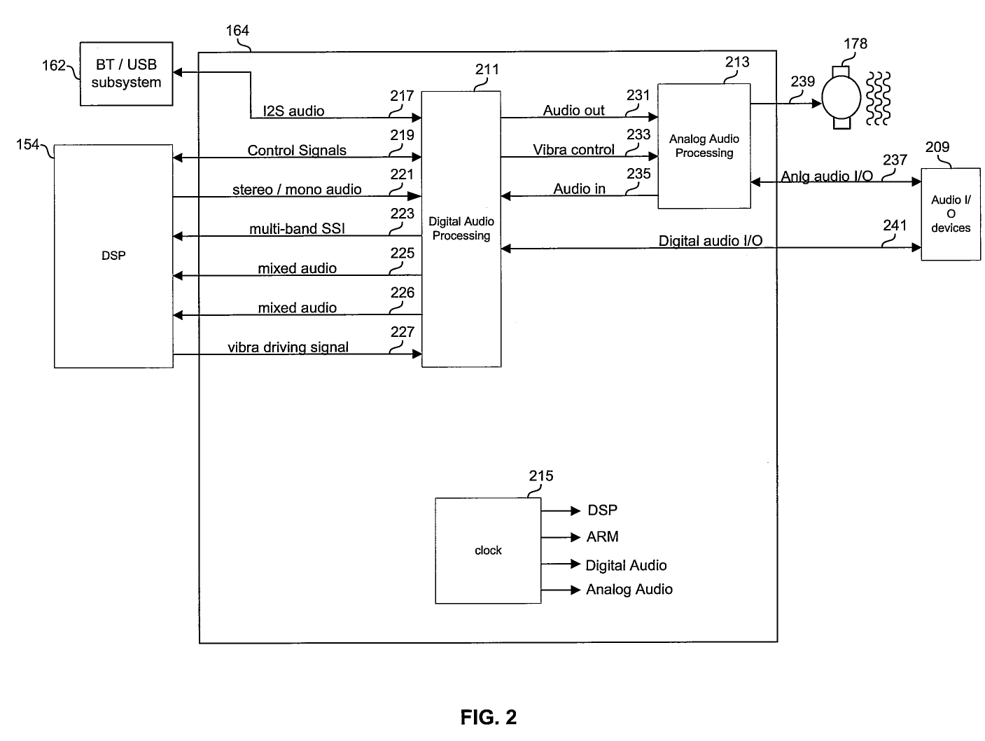

FIG. 2 is a block diagram illustrating an exemplary audio processing device, in accordance with an embodiment of the invention. Referring to FIG. 2, there is shown the DSP 154, the BT and/or USB subsystem 162, the audio processing device 164, and audio input and/or output devices 209. The audio input and/or output devices 209 may comprise one or more devices such as the external headset port 166, the analog microphone 168, the speakers 170, the Bluetooth headset 172, the hearing aid compatibility (HAC) coil 174, the dual digital microphone 176, and the vibration transducer 178 described with respect to FIG. 1. The DSP 154 and the BT and/or USB subsystem 162 may be as described with respect to FIG. 1. The audio processing device 164 may be as described with respect to FIG. 1 and may comprise a digital portion 211, an analog portion 213, and a clock 215.

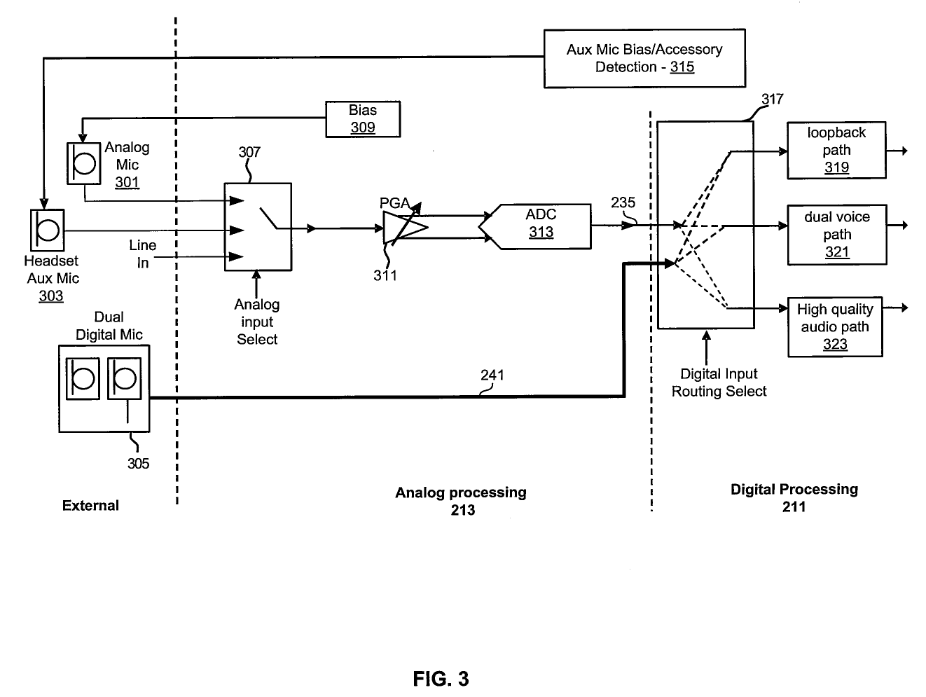

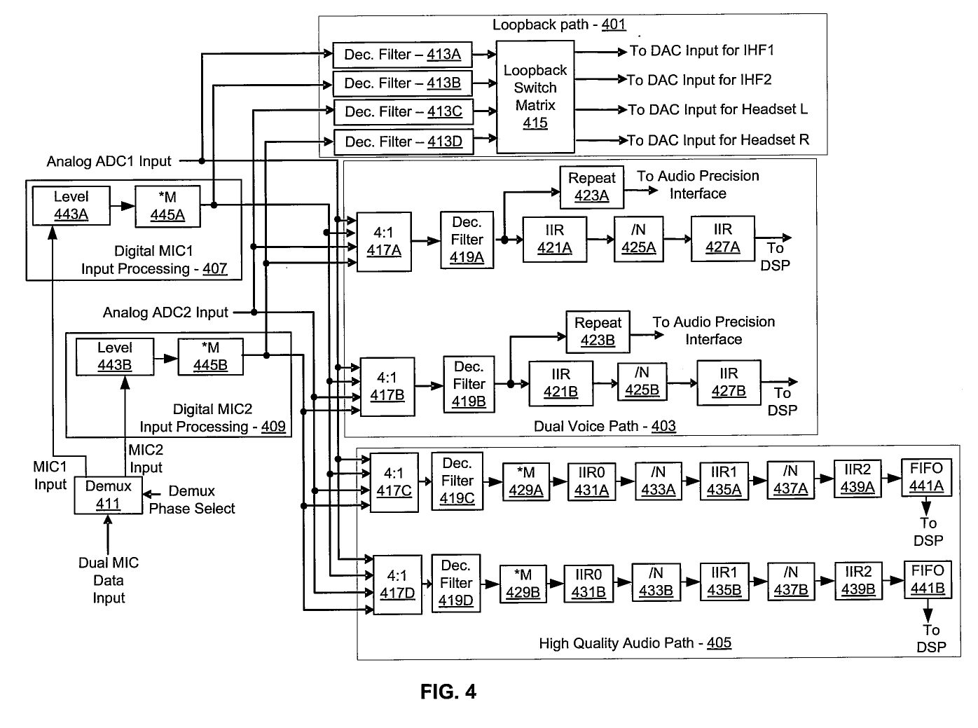

The digital portion 211 may comprise suitable logic, circuitry, and/or code that may enable processing audio signals in the digital domain. In this regard, the digital portion 211 may be operable to filter, buffer, up-sample, down-sample, apply a digital gain or attenuation to, route, and/or otherwise condition digital audio signals. Additional details of the digital portion 211 are described below with respect to FIGS. 3 and 4.

The analog portion 213 may comprise suitable logic, circuitry, and/or code that may enable converting digital audio signals to an analog representation and amplifying and/or buffering the analog signals for driving audio output devices. Additional details of the analog portion 213 are described below with respect to FIG. 3.

The clock 215 may comprise suitable logic, circuitry, and/or code that may be operable to generate one or more periodic signals. The clock 215 may, for example, comprise one or more crystal oscillators, phase locked loops (PLLs), and/or direct digital frequency synthesizers (DDFS). The clock 215 may output a plurality of signals each with a distinct frequency and/or phase. The signals output by the clock 215 may be conveyed to one or more of the digital portion 211, the analog portion 213, the DSP 154, the memory 158, and/or the processor 156.

In various exemplary embodiments of the invention, one or more audio signals 217 may be communicated between the digital portion 211 and the BT and/or USB subsystem 162 via an inter-IC sound (I²S) bus. Each of the audio signals 217 may be a monaural channel, a left stereo channel, or a right stereo channel. In an exemplary embodiment of the invention, the BT and/or USB subsystem 162 may be enabled to receive and/or process audio broadcasts, and thus, two signals 217 comprising left and right channel audio may be conveyed to the digital portion 211 via an I²S bus. In this regard, exemplary audio broadcasts may comprise FM stereo, “HD radio”, DAB, DAB+, and satellite radio broadcasts.

In various exemplary embodiments of the invention, one or more output audio signals 231, vibration control 233, and input audio signals 235 may be communicated between the digital portion 211 and the analog portion 213.

The output audio signals 231 may each comprise one or more digital audio signals which have been suitably processed and/or conditioned by the digital portion 211 for output via one or more of the audio output devices 209. Each of the audio signals 231 may be a monaural channel, a left stereo channel, or a right stereo channel. Each of the output audio signals 231 may be converted to an analog representation and amplified by the analog portion 213.

The input audio signals 235 and 241 from an audio input device 209 may each comprise one or more digital audio signals to be processed by the digital portion 211. The input audio signals 235 and/or 241 may comprise monaural and/or stereo audio data which the digital portion 211 may process for conveyance to the DSP 154 and subsequent transmission to a remote wireless device. The input audio signals 235 and/or 241 may comprise monaural and/or stereo audio data which the digital portion 211 may process in a “loopback” path for conveyance to one or more audio output devices 209.

The vibration control signal 233 may be a pulse width modulated square wave that may, after being amplified by the analog portion 213, control vibration of the vibration transducer 178. In various exemplary embodiments of the invention, spectral shaping techniques may be applied in the pulse width modulation function to reduce noise in the audible band.

In various exemplary embodiments of the invention, one or more control signals 219, one or more audio signals 221, one or more SSI signals 223, one or more mixed audio signals 225 and/or 226, and one or more signals 227 for driving a vibration transducer may be communicated between the DSP 154 and the digital portion 211. Monaural and/or stereo audio data may be extracted from RF signals received by the receiver 153 and processed by the DSP block 154 before being conveyed to the digital portion 211 of the processing device 164. One or more signals communicated between the DSP 154 and the digital portion 211 may be buffered. For example, voice signals may not be buffered while music and/or ringtone signals may be written to a first-in-first-out (FIFO) buffer by the DSP 154 and then fetched from the FIFO by the digital portion 211.

The one or more control signals 219 may be utilized to configure various operations of the digital portion 211 based, for example, on a resolution and/or sampling rate of signals being output by the DSP 154. In various embodiments of the invention, one or more control registers for the digital portion 211 may reside in the DSP 154. In various embodiments of the invention, the control signals 219 may comprise one or more interrupt signals.

The audio signals 221 may each comprise, for example, voice data, music data, or ringtone data. Each audio signal 221 may be monaural signal, a left stereo channel, or a right stereo channel. The digital portion 211 may condition and/or process the audio signals 221 for conveyance to one or more audio output devices and/or uplink paths. In various embodiments of the invention, the resolution and/or sample rate of the audio signals 221 may vary. Exemplary resolutions may comprise 16-bit and 18-bit resolution. Exemplary sample rates may comprise 8 kHz, 11.05 kHz, 12 kHz, 16 kHz, 22.05 kHz, 24 kHz, 32 kHz, 44.1 kHz, and 48 kHz.

The signal strength indicator (SSI) signals 223 may comprise one or more feedback signals from the digital portion 211 to the DSP 154. The SSI signals 223 may provide an indication of signal strength of one or more frequency bands of one or more audio signals 221, 225, and/or 226. The SSI signals 223 may, for example, be utilized by the DSP 154, the processor 156, the memory 158, or a combination thereof to control a digital gain factor applied to each sub-band of one or more audio signals 221, 225, and/or 226. Additionally, detected signal amplitudes may be utilized to generate an audio visualization. For example, one or more LEDs or an image displayed by the wireless system 150 may be controlled based on the detected signal amplitudes.

The signal 227 may comprise audio data utilized to control a vibration transducer 178. The signal 227 may comprise, for example, CW tone data, voice data, music data, or ringtone data. Characteristics such as intensity of vibration, a pattern in which vibration may be started and stopped, a frequency at which vibration may be started and/or stopped, and/or a duration of a vibration or sequence of vibrations may be controlled based on the signal 227.

The one or more mixed audio signals 225 and the one or more mixed audio signals 226 may be output by the digital portion 211 to the DSP 154. The mixed audio signals 225 may each be a composite signal comprising information from one or more monaural signals and/or stereo audio signals. Similarly, the mixed audio signals 226 may each be a composite signal comprising information from one or more monaural signals and/or stereo audio signals. In this regard, one or more of the audio signals 221, one or more of the input audio signals 235, one or more of the input audio signals 241, and/or one or more of the audio signals 217 may be mixed together. Each of the audio signals 221, 235, 241, and 217 may be, for example, amplified, attenuated, band limited, up-converted, down-converted or otherwise processed and/or conditioned prior to mixing. The mixed audio signals 225 may be part of and/or coupled to an uplink path. For example, the signals 225 may be processed by the DSP 154 and transmitted, via the BT and/or USB subsystem 162, to a remote wireless system. Similarly, the mixed audio signal) 226 may be part of and/or coupled to an uplink path. For example, the signals 226 may be processed by the DSP 154 and transmitted, via the transmitter 152, to a far-end communication partner or a remote wireless system.

In operation, one or more baseband audio signals 217, 221, 235, and/or 241 may be conveyed to the audio processing device 164 from one or more of the DSP 154, the BT and/or USB subsystem 162, and the input and/or output devices 209. The digital portion 211 of the audio processing device 164 may select which baseband audio signals 221 to process. Each of the selected audio signals may be processed based on factors such as whether the signal may be one of a pair of stereo signals or may be a monaural signal; whether the signal comprises voice, music, or ringtone data; a resolution of the signal; and a sample rate of the signal. In this regard, selected voice signals may be processed via a two or more voice processing paths in the hardware audio CODEC, where each of the two or more voice processing paths may be configured independently of the other path. In an exemplary embodiment of the invention, the dual voice processing paths may enable, for example, having a narrow band (e.g. 8 kHz) voice call while recording a wideband (e.g. 16 kHz) version of the call. In an exemplary embodiment of the invention, dual voice processing paths may enable, for example, audio beamforming to enhance the desired audio signal while suppressing undesired noise and/or interference.

FIG. 3 is a block diagram of an exemplary audio transmit processing system in accordance with an embodiment of the invention. Referring to FIG. 3, there is shown an analog microphone 301, a headset auxiliary microphone 303, a dual digital microphone 305, an analog input select switch 307, a bias circuit 309, a programmable gain amplifier (PGA) 311, an analog to digital converter (ADC) 313, an auxiliary microphone bias and accessory detection block 315, a digital input routing switch 317, a loopback path 319, dual voice path 321, and high quality audio path 323. There is also shown an analog input select signal and a digital input routing select signal.

The analog microphone 301, the headset auxiliary microphone 303, and the dual digital microphone 305 may be located external to the CODEC 164, described with respect to FIG. 2. The bias circuit 309, the analog input select switch 307, the PGA 311, and the ADC 313 may comprise a mixed-signal block in the CODEC 164, whereas the digital input routing switch 317, the loopback path 319, the dual voice path 321, and the high quality audio path 323 may comprise a digital block in the CODEC 164. The auxiliary microphone bias and accessory detection block 315 may comprise circuitry within the mixed signal and the digital blocks of the CODEC 164.

The analog microphone 301 may comprise suitable circuitry, logic, and/or code that may be operable to detect sound waves and convert them to electrical signals via a piezoelectric effect, for example. The electrical signals generated by the analog microphone 301 may comprise analog signals that may require analog to digital conversion before processing. The analog microphone 301 may be integrated in a wireless system, such as the wireless system 150 described with respect to FIG. 1.

The headset auxiliary microphone 303 may comprise suitable circuitry, logic, and/or code that may be operable to detect sound waves and convert them to electrical signals via a piezoelectric effect, for example. The electrical signals generated by the analog microphone 301 may comprise analog signals that may require analog to digital conversion before processing. The headset auxiliary microphone 303 may be integrated in a headset that may be communicatively coupled with the wireless system 150.

The dual digital microphone 305 may comprise suitable circuitry, logic, and/or code that may be operable to detect sound waves and convert them to electrical signals. The electrical signals generated by the dual digital microphone 305 comprise digital signals, at 1.625 MHz or 3.25 MHz, for example, and thus may not require analog to digital conversion prior to digital processing. The dual digital microphone 305 may comprise a micro-electromechanical systems (MEMS) microphone, for example.

The analog input select switch 307 may comprise suitable circuitry, logic, and/or code that may be operable to select which analog source signal may be communicated to the PGA 311. The analog input select switch 307 may receive as inputs the analog signals generated by the analog microphone 301, the headset auxiliary microphone 303, and the Line In signal, The analog input select signal may determine which of the analog signals to communicate to the PGA 311. In this manner, multiple analog sources may be utilized while only requiring one ADC, the ADC 313. The invention is not limited to the number of analog sources shown in FIG. 3. Accordingly, the number of microphones or other input sources may be any number as required by the wireless system 150.

The bias circuit 309 may comprise suitable circuitry, logic, and/or code that may be operable to bias the analog microphone 301 for proper operation. The auxiliary microphone bias and accessory detection block 315 may comprise circuitry, logic, and/or code that may determine when the headset auxiliary microphone 303 may be present and may then bias accordingly for proper operation.

The ADC 313 may comprise suitable circuitry, logic, and/or code that may convert an analog signal to a digital signal. The ADC 313 may receive as an input signal, the signal generated by the PGA 311, and may communicate an output digital signal to the digital input routing switch 317. The ADC 313 may comprise a second-order delta-sigma modulator, for example.

The digital input routing switch 317 may comprise suitable circuitry, logic, and/or code that may be operable to select which digital source signal may be communicated to the loopback path 319, the dual voice path 321, and the high quality audio path 323. The digital input routing switch 317 may receive as inputs the digital signals generated by the ADC 313 and the dual digital microphone 305, as well as the digital input routing select signal to determine where each of the digital signals may be directed. In this manner, multiple digital sources may be utilized while only requiring a single loopback path. The invention is not limited to the number of digital sources shown in FIG. 3. Accordingly, the number of digital microphones or other digital input sources may be any number as required by the wireless system 150. Although dual voice path 321 is illustrated, the invention is not limited in this regard and more than 2 voice processing path may be utilized without departing from the breath and/or scope of various embodiments of the invention.

The loopback path 319 may comprise suitable circuitry, logic, and/or code that may enable processing, for example, up to four audio signals for conveyance to an audio output device. Less than 4 or more than 4 audio paths may be utilized without departing from the breath and/or scope of various embodiments of the invention. The loopback path 319 may comprise one or more filters and/or sample rate converters for processing audio signals. For example, in a production test environment, the audio signals from a microphone may be desired in the audio signal played back by a speaker. The loopback path 319 may also perform sample rate conversion so that the signals looped back to a downlink path may be at an acceptable sampling rate. In an exemplary embodiment of the invention, the ADC signal 235 may be 3 level signal sampled at 26 MHz while a DAC communicatively coupled to an audio output device may accept 23-bit signal sampled at 6.5 MHz.

The dual voice path 321 may comprise suitable circuitry, logic, and/or code that may be operable to independently process each of a pair of audio signals received from the routing switch 317. In this regard, the dual voice path 321 may comprise a plurality of filters and/or sample rate converters for processing audio signals for conveyance to the digital signal processor 203. In this regard, audio signals selected for processing in the dual voice path 321 may be down-sampled to voice band signals with a sample rate of, for example, 17-bits at 8 kHz or 16 kHz. Although a dual voice path is depicted, aspects of the invention may be extended to simultaneously process three or more voice band signals.

The high quality audio path 323 may comprise suitable circuitry, logic, and/or code that may be operable to independently process each of a pair of audio signals received from the routing switch 317. In this regard, the high quality audio path 323 may comprise a plurality of filters and/or sample rate converters for processing high quality audio signals, such as 23-bit audio signals sampled at 48 kHz, for conveyance to the digital signal processor 203.

In operation, the analog microphone 301 and the headset auxiliary microphone 303 may be operable to receive sound signals and convert them into electrical signals that may be communicated to the analog input select switch 307. The analog input select signal may define which analog signal may be communicated to the PGA 311 for amplification. The signal amplified by the PGA 311 may be communicated to the ADC 313 for conversion to a digital representation. The digital signal generated by the ADC 313 and the digital signals from the dual digital microphone may be communicated to the digital input routing switch 317 which may be configured by the digital input routing select signal to communicate the digital signals to one or more of the loopback path 319, the dual voice path 321, and/or the high quality audio path 323. The loopback path 319 may process a plurality of signals from the digital input routing switch 317 for output via one or more local audio output devices, such as the speakers 170 or via the external headset port 166. The dual voice path 321 may select two of the signals from the digital input routing switch 317 and process each signal independently for conveyance to the DSP 154. In this manner, the dual voice processing path 321 may enable, for example, having a narrow band (e.g. 8 kHz) voice call while recording a wideband (e.g. 16 kHz) version of the call. The high quality audio path 323 may select two of the signals from the digital input routing switch 317 and process each signal independently for conveyance to the DSP 154. In various embodiments of the invention, DSP 154 may implement post-processing algorithms such as audio beamforming.

FIG. 4 is a block diagram illustrating exemplary digital audio processing hardware, in accordance with an embodiment of the invention. Referring to FIG. 4, there is shown a loopback path 401, a dual voice path 403, a high quality audio path 405, digital microphone processing blocks 407 and 409, and a demultiplexer (demux) 411.

The loopback path 401 may be similar to or the same as the loopback path 319 described with respect to FIG. 3. The loopback path 401 may comprise decimation filters 413A-413D, and a loopback switch matrix 415.

The dual voice path 403 may be similar to or the same as the dual voice path 321 described with respect to FIG. 3. The dual voice path 403 may comprise the 4:1 select blocks 417A and 417B, decimation filters 419A and 419B, infinite impulse response (IIR) filters 421A, 421B, 427A, and 427B, repeat blocks 423A and 423B, and decimate-by-N blocks 425A and 425B.

The high quality audio path 405 may be similar to or the same as the high quality path 323 described with respect to FIG. 3. The high quality audio path 405 may comprise, 4:1 select blocks 417C and 417D, decimation filters 419C and 419D, repeat-by-M blocks 429A and 429B, IIR0 filters 431A and 431B, decimate-by-N blocks 433A, 433B, 437A, and 437B, IIR1 filters 435A and 435B, 11R2 filters 439A and 439B, and FIFO blocks 441A and 441B.

The digital mic1 input processing block 407 may comprise a level conversion block 443A and a repeat-by-M block 445A. The digital mic2 input processing block 409 may comprise a level block 443B and a repeat-by-M block 445B.

The de-multiplexer (demux) 411 may comprise suitable circuitry, logic, and/or code that may be operable to separate two signals from a single received signal. The demux 411 may receive as inputs an output signal generated by a dual digital microphone and a demux phase select signal. The phase select signal may be utilized to configure the demux 411 to communicate the separate signals to appropriate output ports.

The decimation filters 413A-413D may comprise suitable circuitry, logic, and/or code that may enable down-sampling of the sampling frequency of a received signal by an integer value. The decimation filters 413A-413D may be communicatively coupled to the loopback switch 415. The loopback switch 415 may comprise suitable circuitry, logic, and/or code that may communicatively couple each of the signals generated by the decimation filters 413A-413D to desired outputs, such as a DAC input for (integrated hands free) IHF speakers or a headset, for example.

The 4:1 select blocks 417A, 417B and 417C, 417D may comprise suitable circuitry, logic, and/or code that may be operable to select one of the plurality of input signals for processing by the dual voice path 403 and the high quality audio path 405, respectively. In this manner, multiple signals may be processed by any one of the signal paths 401, 403, and 405. Although a 4:1 select block is depicted, various aspects of the invention may enable selecting from fewer or more than 4 signals.

The decimation filters 419A-419D may comprise suitable circuitry, logic, and/or code that may enable down-sampling the sampling frequency of a received signal by an integer value. The decimation filters 419A-419D may comprise cascaded integrator comb (CIC) filters, for example, and may be utilized to convert a signal frequency down to 40 or 80 kHz, for example. The decimation filters 419A-419D may also comprise a digital gain control.

The IIR filters 421A, 421B, 427A, 427B, 431A, 431B, 435A, 435B, 439A, and 439B may comprise suitable circuitry, logic, and/or code that may be operable to filter received signals to obtain a desired frequency response. The IIR filters 421A, 421B, 427A, 427B, 431A, 431B, 435A, 435B, 439A, and 439B may comprise 2-, 3-, and/or 5-biquad filters, and may compensate for non-ideal frequency response of the analog microphone 301, headset auxiliary microphone 303, and/or digital microphone 305 of FIG. 3, for example.

The repeat blocks 423A and 423B may comprise suitable circuitry, logic, and/or code that may be operable to upsample a 40 kHz signal to an 80 kHz for communication to an audio precision interface. The output signal may comprise an 80 kHz, 17 bit data stream, for example.

The decimate-by-N blocks 425A, 425B, 433A, and 433B may comprise suitable circuitry, logic, and/or code that may divide the sampling frequency of the received signals by an integer N. Similarly, the repeat-by-M blocks 429A, 429B, 445A, and 445B may comprise suitable circuitry, logic, and/or code that may multiply the sampling frequency of the received signals by an integer M. In this manner, digital samples received at different sampling frequencies may be converted to a common sampling frequency for subsequent processing. The values for M and N may be different for any given decimate-by-N or repeat-by-M blocks, depending on the desired sampling frequency.

The FIFO blocks 441A and 441B may comprise suitable circuitry, logic, and/or code that may be operable as a buffer and temporarily store data before being communicated to a DSP, such as the DSP 154 described with respect to FIG. 2.

The level conversion blocks 443A and 443B may comprise suitable circuitry, logic, and/or code that may convert the number of levels of the received signal. For example, the level conversion blocks 443A and 443B may convert received signals from 3.25 MHz, 2-level signal to a 3.25 MHz, 3-level signal.

In operation, a digital microphone, such as the dual digital microphone 305, described with respect to FIG. 3, may generate a digital signal that may be demultiplexed by the demux 411 to generate two signals, the MIC1 and MIC2 inputs. The MIC1 and MIC2 inputs may be converted to a 3-level signal, for example, by the level conversion blocks 443A and 443B. The converted signals may be upsampled by the repeat-by-M blocks 445A and 445B, creating two of the four signals that may be selected for processing by the loopback path 401, the dual voice path 403, and/or the high quality audio path 405. The ADC1 and ADC2 input signals may comprise two additional signals that may be selected.

The loopback path 401 may be utilized to communicate any of the four inputs; such as from digital or analog microphones, stereo line in, or FM signals, for example; to a DAC delta-sigma modulator for conveyance to an audio output device such as the speakers 170 or a headset via the headset port 166. To achieve this, for example, a 3-level 26 MHz signal may be down-sampled by a factor of 4 to 6.5 MHz 23-bit by the decimation filters 413A-413D, and then may be routed to a DAC delta-sigma modulator.

In an exemplary embodiment of the invention, two 3-level 26 MHz signals may be selected in the dual voice path 403 from the a plurality of input sources and the selected signals may be down-sampled to 40 KHz/80 KHz. The down sampling may be performed by a CIC decimation filter. The decimation ratio of the CIC decimation filter may be determined based on the final ADC output sampling rate (8 KHz/16 KHz), The decimation filters 419A and 419B may be dependent on the final ADC output sampling rate, such that the frequency response for a higher sampling rate (16 KHz) may be greatly improved. The output of the decimation filters 419A and 419B may be communicated to an Audio Precision interface via a repeat block 423A or 423B and/or to the IIR filters 421A and 421B. The dual voice path 403 may comprise, for example, two parallel and identical processing branches, and the input to each branch may be selected independently. More than 2 parallel paths may be utilized without departing from the breath and/or scope of various embodiments of the invention. In some embodiments of the invention, the paths may differ. The output sampling frequency may also be independently configured. In this manner, a first branch of the dual voice path 403 may utilize a lower sampling frequency for voice communication and a second branch of the dual voice path 403 may utilize a higher sampling for recording, for example.

In an exemplary embodiment of the invention, a 3-level, 26 MHz signal may be selected in the high quality audio path 405, independent of the signals selected in the dual voice path 403 and the loopback path 401. Signals selected in the high quality audio path 405 may be down-sampled to 48 kHz via a cascade of decimation and IIR filters, for example. The high quality audio path 405 may comprise two parallel processing branches, and the input to each branch may be selected independently.

In an embodiment of the invention, the digital microphone processing blocks 407 and 409 may receive digital audio signals from a dual digital microphone via the de-multiplexer 411. The received digital audio signals may be processed by the digital microphone processing blocks 407 and 409 before communicating the processed signals to the 4:1 select blocks 417A and 417B in the dual voice path 403, the 4:1 select blocks 417C and 417D in the high quality audio path 405, and one or more of the decimation filters 413A-413D in the loopback path 401.

Each signal selected by the 4:1 select blocks or circuits 417A and 417B may be filtered and down-sampled to an 8 kHz or 16 kHz voice band signal to be communicated to the DSP 154. Which signal(s) are selected by the select blocks or circuits 417A and 417B may be configured, possibly in real-time, via one or more control signals from, for example, the processor 156, the memory 158, and/or the DSP 154. In this regard, a signal selected by select block or circuits 417A may be independent of which signal may be selected by select block 417B. Coefficients of filters 421A, 421B, 427A, and 427B may be configured, for example, in real-time, via one or more control signals from, for example, the processor 156, the memory 158, and/or the DSP 154. In this regard, coefficients of filters 421A and 421B in one processing branch of the dual voice path 403 may be configured independent of coefficients of filters 421B and 427B in another processing branch of the dual voice path 403. The decimation filters 419A and 419B may be configured via various settings, for example in real-time, via one or more control signals from, for example, the processor 156, the memory 158, and/or the DSP 154. In this regard, settings for the decimation filters 419A in one processing branch of the dual voice path 403 may be configured independent of settings of decimation filters 419B in another processing branch of the dual voice path 403.

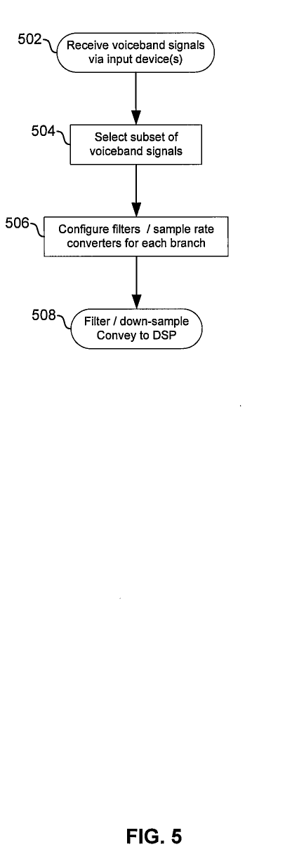

FIG. 5 is a flow chart illustrating exemplary steps for simultaneously processing a plurality of voice band signals in an audio CODEC, in accordance with an embodiment of the invention. Referring to FIG. 5, the exemplary steps may begin with step 502 when one or more audio signals from the microphones 301 and/or 305, for example, may be input to the audio CODEC 164. Subsequent to step 502, the exemplary steps may advance to step 504. In step 504, two or more of the received audio signals may be selected for further processing by the dual voice path 403 and subsequent conveyance to the DSP 154. In some instances, the two or more selected signals may originate from the same source and may be identical or nearly identical signals. The processing may occur simultaneously. In this regard, each of a plurality of select blocks, such as the 4:1 select blocks 417A and 417B, may select an audio signal to be filtered and down-sampled to a voice band signal of 8 kHz or 16 kHz. Subsequent to step 504, the exemplary steps may advance to step 506. In step 506, filters and sample-rate converters in each branch of the dual voice path 403 may be configured so as to output voice band signals of an appropriate sample rate. Subsequent to step 506, the exemplary steps may advance to step 508. The selected audio signals may be filtered and down-sampled to generate voice band signals which may be communicated to the DSP 154. In this manner, a plurality of audio signals may be processed and/or converted to voice band signals by a corresponding plurality of branches in the dual voice path 403.

Exemplary aspects a method and system for dual voice path processing in an hardware audio CODEC are provided. In an exemplary hardware audio CODEC 164, two or more signals received via one or more audio input devices, such as the microphones 301, 303 and 305, may be selected for processing. The selected signals may be filtered and down-sampled via two or more signal processing branches of the dual voice path 403. Furthermore, an output sample rate of each of the two or more signal processing branches of the dual voice path 403 may be configured independently. The two or more signal processing branches of the dual voice path 403 may each comprise one or more IIR filters 421 and/or 427 with configurable coefficients. The two or more signal processing branches of the dual voice path 403 may also each comprise one or more cascaded-integrate-comb (CIC) decimation filters 419 with configurable decimation ratio. A first of the selected two or more signals, may be filtered and/or down-sampled to generate a signal having a first, lower, sample rate and a second of the selected two or more signals may be filtered and/or down-sampled to generate a signal having a second, higher, sample rate. In this regard, the signal having first, lower, sample rate may be transmitted to a remote device while the signal having a second, higher, sample rate may be stored in the memory 158. A first of the selected signals and a second of the selected signals may comprise the same or similar audio content. The output sampling rate of the signal processing branches may be 8 kHz or 16 kHz. The filtered and/or down-sampled signals may be post-processed by the DSP 154. For example, the filtered and/or down-sampled signals may be combined in such a way that background noise or interference may be suppressed while the quality of the intended signal may be preserved. The selected audio signals may comprise voice band audio content.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for dual voice path processing in an audio CODEC.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. One embodiment utilizes a commercially available processor, which may be implemented external to an ASIC implementation of the present system. Alternatively, in an embodiment where the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for signal processing, the method comprising:
in a hardware audio CODEC:
selecting two or more signals received via one or more audio input devices;
filtering and down-sampling each of said selected two or more signals via two or more signal processing branches in said hardware audio CODEC, wherein an output sample rate of each of said two or more signal processing branches is configured independently.

2. The method according to claim 1, wherein each of said two or more signal processing branches comprises one or more IIR filters with configurable coefficients.

3. The method according to claim 1, wherein each of said two or more signal processing branches comprises one or more cascaded-integrate-comb (CIC) decimation filters with configurable decimation ratio.

4. The method according to claim 1, comprising:
filtering and/or down-sampling a first of said selected two or more signals to generate a signal having a first, lower, sample rate; and
filtering and/or down-sampling a second of said selected two or more signals to generate a signal having a second, higher, sample rate.

5. The method according to claim 4, comprising transmitting said generated signal having a first, lower, sample rate to a remote device.

6. The method according to claim 4, comprising storing said generated signal having a second, higher, sample rate to memory.

7. The method according to claim 4, wherein said first of said selected two or more signals and said second of said selected two or more signals comprise similar audio content.

8. The method according to claim 1, wherein said output sampling rate of each of said two or more signal processing branches is either approximately 8 kHz or approximately 16 kHz.

9. The method according to claim 1, comprising post-processing said filtered and/or down-sampled signals to suppress noise and/or interference.

10. The method according to claim 1 wherein said selected two or more received signals comprise voice band audio content.

11. A system for signal processing, the system comprising:
one or more circuits in a hardware audio CODEC, said one or more circuits operable to:
select two or more signals received via one or more audio input devices; and
filter and down-sample each of said selected two or more signals via two or more signal processing branches in said hardware audio CODEC, wherein an output sample rate of each of said two or more signal processing branches is configured independently.

12. The system according to claim 11, wherein each of said two or more signal processing branches comprises one or more IIR filters with configurable coefficients.

13. The system according to claim 11, wherein each of said two or more signal processing branches comprises one or more cascaded-integrate-comb (CIC) decimation filters with configurable decimation ratio.

14. The system according to claim 11, wherein said one or more circuits are operable to:
filter and/or down-sample a first of said selected two or more signals to generate a signal having a first, lower, sample rate; and
filter and/or down-sample a second of said selected two or more signals to generate a signal having a second, higher, sample rate.

15. The system according to claim 14, wherein said one or more circuits are operable to transmit said generated signal having a first, lower, sample rate to a remote device.

16. The system according to claim 14, wherein said one or more circuits are operable to store said generated signal having a second, higher, sample rate to memory.

17. The system according to claim 14, wherein said first of said selected two or more signals and said second of said selected two or more signals comprise similar audio content.

18. The system according to claim 11, wherein said output sampling rate of each of said two or more signal processing branches is either approximately 8 kHz or approximately 16 kHz.

19. The system according to claim 11, wherein said one or more circuits are operable to post-process said filtered and/or down-sampled signals to suppress noise and/or interference.

20. The system according to claim 11, wherein said selected two or more received signals comprise voice band audio content.
